(19) United States
(12) Patent Application Publication
(10) Pub. No.: US 2023/0316221 A1
(43) Pub. Date: Oct. 5, 2023

(54) SYSTEM AND METHOD FOR SPACE PLANNING FOR WORKSPACE CHANGES

(71) Applicant: Melissa St. John, Indianapolis, IN (US)

(72) Inventor: Melissa St. John, Indianapolis, IN (US)

(21) Appl. No.: 17/712,297

(22) Filed: Apr. 4, 2022

(51) Int. Cl. G06Q 10/08; G06Q 10/06

(52) U.S. Cl. CPC G06Q 10/087; G06Q 10/06311; G06Q 10/06313

(57) ABSTRACT

A system includes a handheld device configured to generate data corresponding to a furniture inventory item at a first location. A database is configured to receive the data and store the data as a record in the database. The record in the dataset includes at least a condition of the inventory item. A process module identifies a condition of the inventory item, and a second location or condition is determined based on the condition.

### TECHNICAL FIELD

The present disclosure relates to space planning for workplace changes and, more particularly, to planning and managing workspace changes such as creating a new workspace, launching a new space or refreshing a current workspace.

### BACKGROUND

There are products currently available to assist with project management of corporate moves: scheduling products, project management tools (e.g., Gantt chart software), and move management tools that are typically part of a large facility management software program. Relocation assistance products tend to be scheduling based or project management based, often utilizing proprietary web-based software to schedule move activities, map re-organization of human resources, and the like. However, existing tools are not comprehensive, and office relocations continue to pose significant financial risk.

Meanwhile, current trends in the workforce indicate that traditional physical workspaces occupied by employees or contractors for an extended period of time are becoming obsolete. Workers are increasingly mobile, often sharing space and facilities on an ad hoc basis, and businesses are increasingly becoming virtual distributed entities without walls. For instance, more and more professionals are working out of the office, only occasionally visiting a home office for face-to-face meetings with colleagues. They may work from home, at a client office, from a local café, or anywhere that a network connection is available, without maintaining a permanent office. Salespeople, consultants, and some employees who may only require access to an office for, say, 20% of their time, may use temporary office space with connectivity outlets and access to office equipment. Field contractors or consultants dispatched to a customer site for a few days to a few weeks or months may cause the workforce to be in a continuous state of flux. Yet, these mobile workers need the support of information technology, human resources, and other business services to be productive, and therefore must stay connected to their co-workers electronically, if not physically.

The present inventor recognizes that corporate culture management during a change event, and providing ongoing services to mobile workers are important, yet sometimes hidden, aspects of a mobile workforce. A healthy corporate culture must weather change and accommodate today's mobile workforce. Uprooting stationary workers from their permanent work spaces can be highly disruptive while many workers without permanent work spaces are constantly on the move. Though assistance tailored to specific needs of a business can be provided by a consultant to assist in integrating cultural elements with a move project, the present inventor recognizes that consultants tend to be cost-effective for large companies and same city businesses while such consulting resources may not be available to small, medium-sized, or remote businesses.

Applicant's disclosure is directed to addressing these needs.

### SUMMARY

The present disclosure relates to a system and method for space planning for workspace changes, including re-purposing, re-using, and/or discarding furniture.

A system according to one aspect of the present disclosure includes a handheld device configured to generate data corresponding to inventory, such as a furniture inventory, at a first location. A database is configured to receive the data and store the data as a record in the database. The record in the database may include the condition, make, model, size and a photo of the inventory item, as well as the destination of the inventory item. The destination of the inventory item, such as furniture inventory, may be determined, according to the present disclosure based on the condition of the inventory item and the needs of the end-user.

A method according to one aspect of the present disclosure includes steps of generating data corresponding to a furniture inventory at a first location using a handheld device and receiving the data at a database and storing the data as a record in the database. A condition is included in the record of the inventory item, and a second location/destination for the inventory item may be determined based on the condition of the inventory item. It should be appreciated that “inventory item” and “furniture inventory” may be used interchangeably throughout the specification, with “furniture inventory” being a more specific type of “inventory item.”

An exemplary method for assigning a condition to furniture inventory may include: assigning an “A” grade if the furniture item is determined to be in good condition and recommended for reuse; a “C” grade may be assigned if the furniture item is in good condition but includes characteristics determined to be undesirable, such as, for example, an undesirable color; and an “F” grade may be assigned if the furniture item is determined to be in bad condition. For example, furniture inventory may be determined to be in bad condition if it is broken, unusable, or has at least one undesirable characteristic.

### BRIEF DESCRIPTION OF THE DRAWINGS

FIG. 1 depicts a block diagram of a process of the present disclosure, according to an exemplary embodiment of the present disclosure.

FIG. 2 depicts a system diagram of a system of the present disclosure, according to an exemplary embodiment of the present disclosure.

FIG. 3 depicts parameters of an exemplary database record in a database, according to an exemplary embodiment the present disclosure.

FIG. 4 is a home screen for a device, such as a handheld device, including an icon for an app, according to an exemplary embodiment of the present disclosure.

FIG. 5 is a folder including job files for the application, according to an exemplary embodiment of the present disclosure.

FIG. 6 is a new project screen for facilitating input of a new project, according to an exemplary embodiment of the present disclosure.

FIG. 7 depicts an exemplary interface facilitating entry of information, manually or electronically, regarding a new project, according to an exemplary embodiment of the present disclosure.

FIG. 8 depicts an exemplary interface for a user to enter additional information regarding inventoried furniture, according to an exemplary embodiment of the present disclosure.

FIG. 9 depicts an exemplary interface for a user to enter yet additional information regarding the inventoried furniture, according to an exemplary embodiment of the present disclosure.

FIG. 10 depicts an exemplary interface for a user to enter further information regarding the furniture, according to an exemplary embodiment of the present disclosure.

FIG. 11 depicts an interface for a user to enter information corresponding to dimensions and subcategories, according to an exemplary embodiment of the present disclosure.

FIG. 12 depicts an interface for an administrator to access information of the system, according to an exemplary embodiment of the present disclosure.

FIG. 13 is a screen depicting available actions with regard to the system, according to an exemplary embodiment of the present disclosure.

Like reference numbers and designations in the various drawings indicate like element.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

Any physical transition a company undertakes can be filled with obstacles. The amount of decision-making and planning required can exponentially increase with more square feet and staff members.

The present disclosure is directed to planning and managing workspace changes that may include creating a new workspace, launching a new space or refreshing a current workspace. Furniture inventory may be one of the largest expenses of such workspace changes, particularly if new furniture is purchased. Planning may include consideration of the overall budget, the viability of new space, IT planning, space planning, determining what furniture to reuse and what to purchase new, and communication with everyone involved with the schedule.

Project management helps manage a renovation, relocation, or reconfiguration. It takes not only making it a smooth transition but coordinating all of the moving pieces. It also involves creating an overall schedule, overseeing an overall budget, vendor invoice auditing, and coordinating with contractor and construction manager.

Furniture and vendor management may occur with furniture inventory with proprietary IDEA software, budgeting, design, specification, bidding, procurement, install and delivery coordination, furniture appraisal, decommissioning, telecommunication/IT services, audio visual, sound masking, data cabling, appliance delivery setup, barcoding/asset management equipment, equipment calibration verification, warehouse coordination and management.

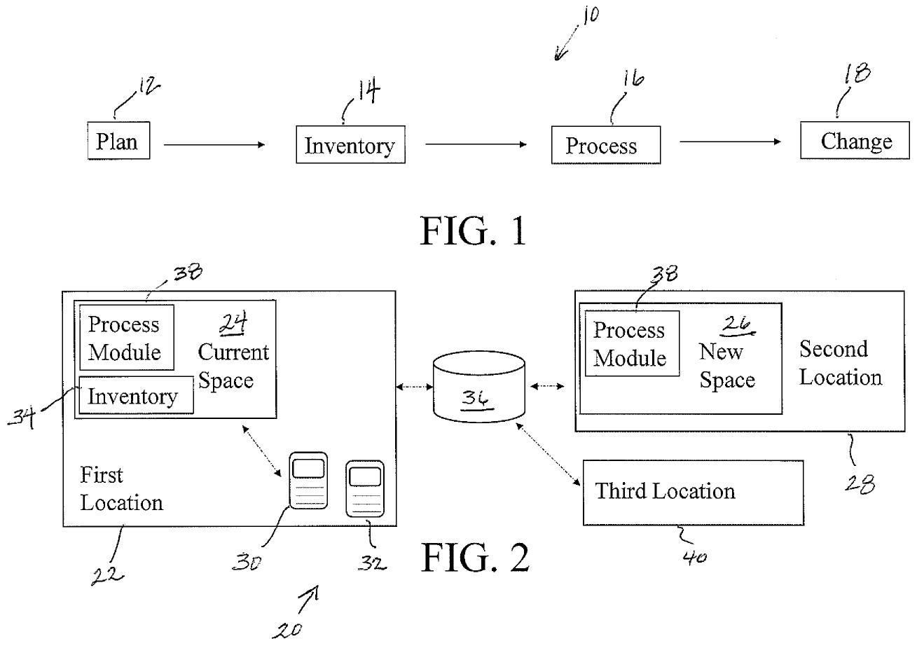

A high level depiction of a system 10 for space planning for workspace changes is shown in FIG. 1. As stated above, the workspace changes may include renovation, relocation, or reconfiguration of a workspace. A plan may be created, at box 12, to define or effectuate a change according to predetermined requirements. At box 14, an inventory may be taken at a site from which inventory is to be accounted for during the move. One or more process modules may be provided, at box 16, to assist in carrying out the software aspects of the system. A change, supported by the teachings of the present disclosure, may occur at box 18, incorporating the system and method provided herein.

Turning now to FIG. 2, a more detailed representation of the system and method is shown generally at 20. A first location 22 may include a current space 24, which is being transitioned, for example, to a new space 26 of a second location 28. As stated above, workplace changes may include, for example, launching a new space or refreshing a current workspace.

One or more handheld devices 30, 32 may be used by users and configured to generate data corresponding to an inventory item 34 at a first location. Handheld devices 30, 32 may read barcodes, serial numbers, and the like. Inventory 34 of the current space 24 can be collected using the handheld devices 30, 32 and transferred to a database 36. The inventory 34 of the existing office content, stored in the database 36, may be simultaneously collected by the handheld devices 30, 32, and then simultaneously submitted to the database 36. That is, the inventory 34 may be collected using different handheld devices 30, 32, recording different pieces of inventory 34 at the same time.

According to one example, the handheld devices 30, 32 may be or may include barcode scanners. Barcode scanners are input devices that use light beams to scan and digitally convert printed barcodes. It then decodes the data and sends the data to a computer. It consists of a lens, a source of light, and a light sensor that translate optical impulses into electrical signals.

The system 10 may include a computer, such as a server or a laptop, which includes a process module 38, or microprocessor, as a computation engine, accessible at multiple locations. The microprocessor may contain the arithmetic, logic, and control circuitry necessary to perform the functions of a digital computer's central processing unit. The system, or, more specifically, the process module 38, may determine a destination, or new space, for the inventory 34 based on the condition of the inventory 34. The process module 38 may communicate with and/or control the operations relative to the database 36. Software may reside on the database 36 to perform the functions described herein.

A method according to one aspect of the present disclosure includes steps of generating data corresponding to a furniture inventory 34 at a first location 22 using a handheld device 30, 32 and receiving the data at a database 36 and storing the data as a record in the database 36. A condition is included in the record of the inventory item, and a second location/destination 28, or third location 40, or alternative or additional locations, for the inventory item 34 may be determined based on the condition of the inventory item 34. It should be appreciated that “inventory item” and “furniture inventory” may be used interchangeably throughout the specification, with “furniture inventory” being a more specific type of “inventory item” in some cases.

An exemplary method for assigning a condition to furniture inventory, such as inventory item 34, may include: assigning an “A” grade if the furniture item 34 is determined to be in good condition and recommended for reuse; a “C” grade may be assigned if the furniture item 34 is in good condition but includes characteristics determined to be undesirable, such as, for example, an undesirable color, style, or size; and an “F” grade may be assigned if the furniture item 34 is determined to be in bad condition. For example, furniture inventory 34 may be determined to be in bad condition if it is broken, unusable, or has at least one undesirable characteristic.

The customized database 36 storing workplace data includes the configuration and capabilities to take inventory 34 of the existing furniture and to facilitate the reconfiguration, relocation and/or right sizing of an office, e.g., current space 24, based on the findings. Further, the database 36 may be configured to develop a tailored strategy to implement the plan 12 of FIG. 1. The database 36 is configured to receive the data and store the data as a record 60 in the database 36.

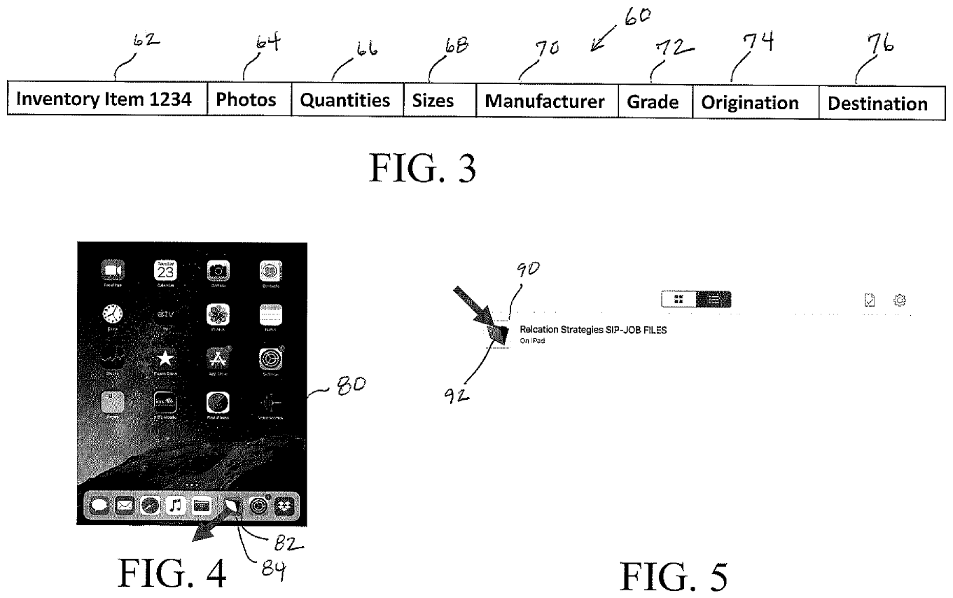

The database 36 may be configured to receive the data from the handheld devices 30, 32 and store the data as a record in the database 36, as shown in FIG. 3. For example, a database record 60 may include an inventory item number field 62, a photos field 64, quantities field 66, sizes field 68, manufacturer field 70, condition/grade field 72, origination field 74, and destination field 76.

According to the exemplary embodiment, to operate the system 10, 20, an app may be opened on a handheld device 30, 32. FIG. 4 may be a home screen 80 of one of the handheld devices 30, 32 including an icon 82 for an app 84 embodying an exemplary embodiment of the present disclosure. The handheld devices 30, 32 may be smart tablets, or similar devices, and may include capabilities for automatically scanning, or manually entering, identifying information from a piece of inventory 34 and transmitting information to the database 36. A database record 60 in the database 36 for the scanned inventory 34 may include information from the handheld devices 30, 32 and/or other sources. select the general file for the respective handheld device 30, 32. This may ensure that the pre-generated prefix will be applied to your inventory project and eliminate duplicates.

FIG. 5 is a folder 90 including job files 92 for the app 84, or application, of the present disclosure. The app 84 launched by the icon 82 may be a type of software that allows performance of specific tasks. The app 84 may be a desktop app or a mobile app, which may be downloaded for mobile/handheld devices 30, 32, such as, for example, smartphones and tablets. An identifier or icon on the screen, for example, may be selected to create a new project. Such activities to operate an app or application and navigate screens should be appreciated by those skilled in the art.

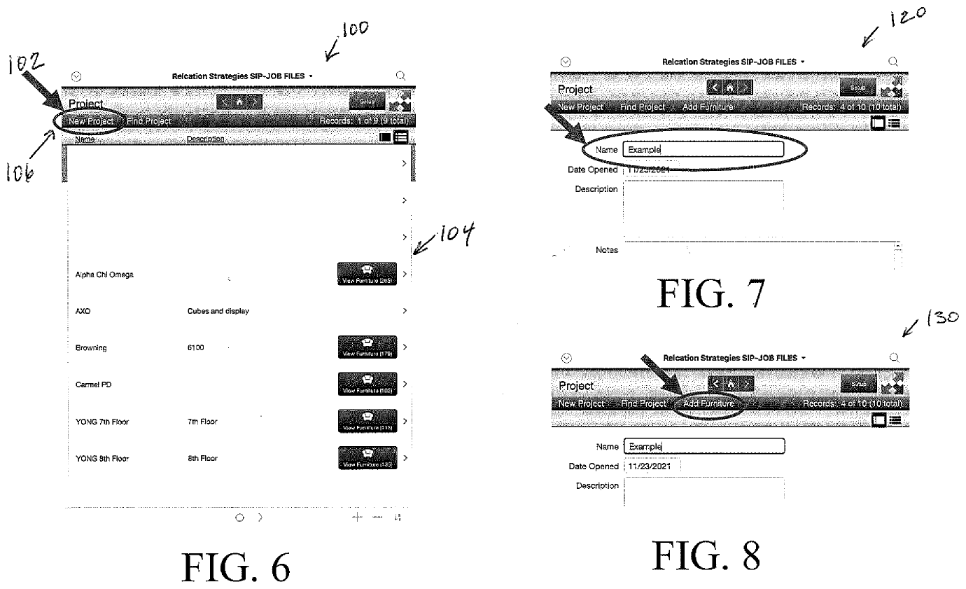

FIG. 6 is an exemplary new project screen 100 that facilitates selection of an existing project, by selecting, or clicking on, an entry 102. Additionally, or alternatively, actuation of a corresponding icon 104 may bring up a record for that project, which includes a listing of the furniture, or other inventory 34, for that location. Creation of a new project may be initiated upon selection of a “new project” icon at 106. The name of a project may be entered to add a description, notes, etc., if needed.

According to the exemplary embodiment, and as shown in FIG. 7, information gathered for a new record, or project, may include, for example, a project name, a date opened, a description and notes. Furniture at the selected location may be added by selecting the “add furniture,” or other inventory, 34 icon at 120. Most or all of the information for the record may be added manually or automatically.

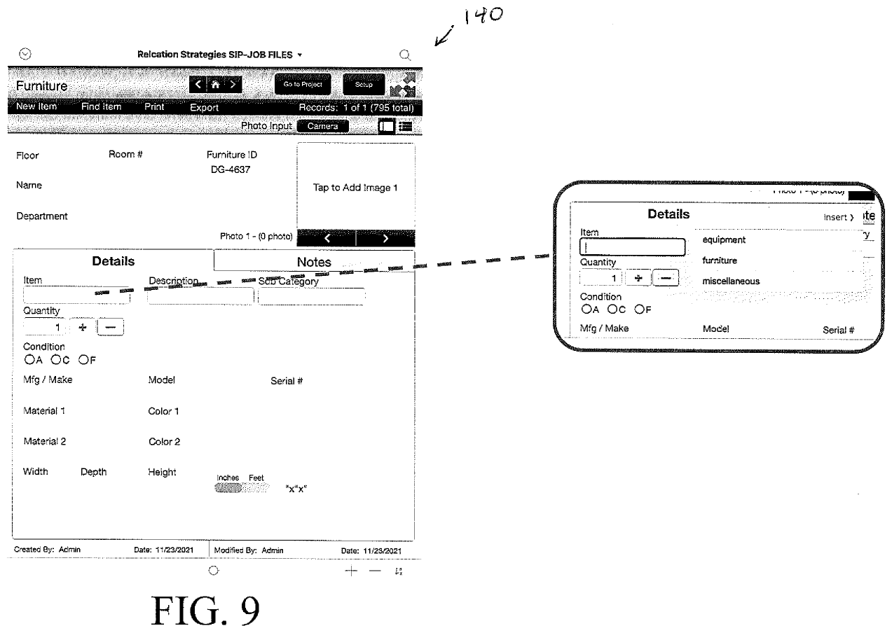

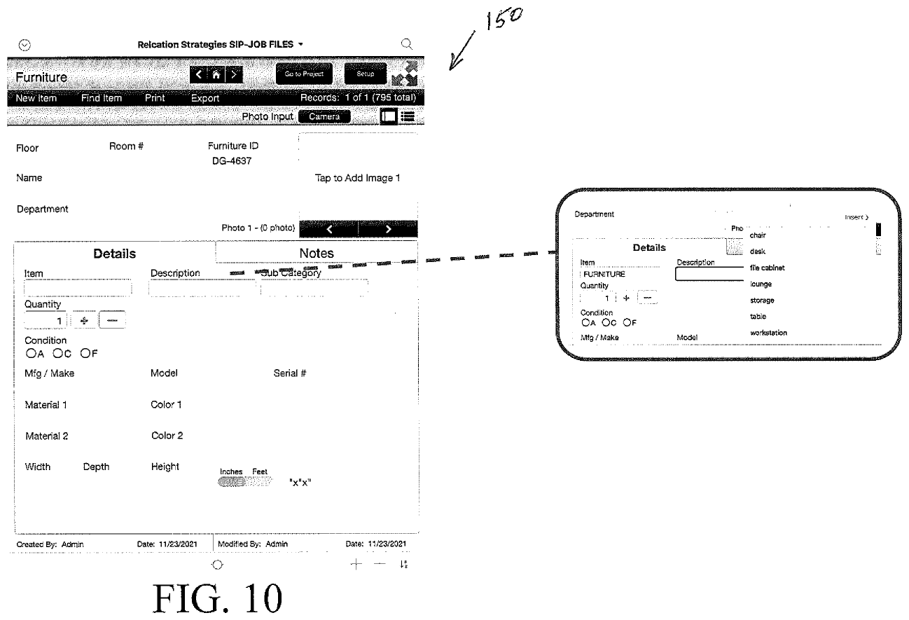

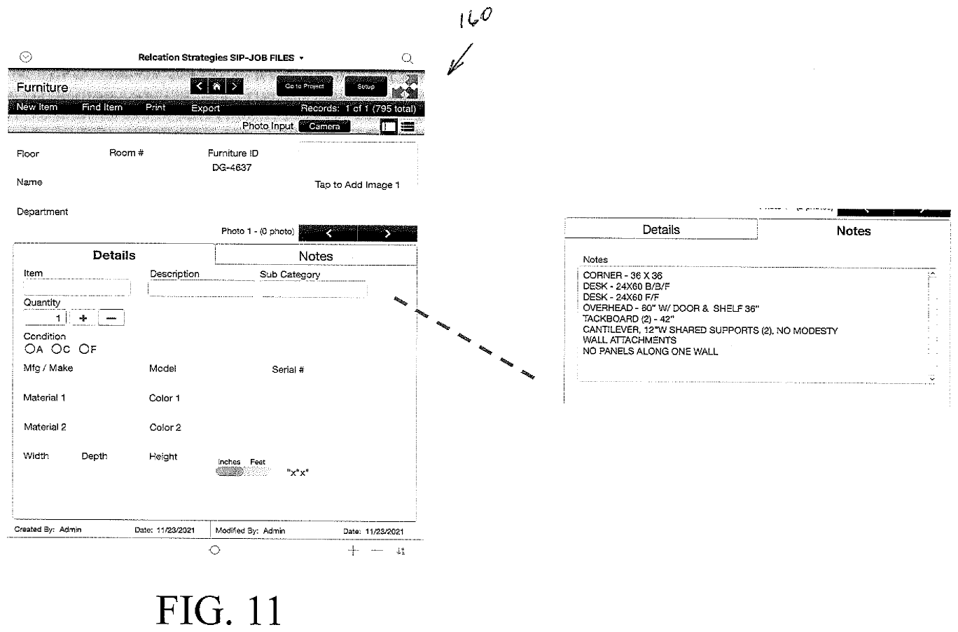

FIG. 8 depicts an exemplary interface 130 for a user to enter furniture, or other inventoried items, 34. The interface 130 facilitates entry of information relevant to the furniture and/or other inventoried items 34. More detailed information regarding the furniture, or other inventoried item, 34 is shown in a dialog 140 in FIG. 9. A picture may be taken, additional information may auto-fill, such as, for example, sub-category, material, and color; however, manual entry may also be conducted. A description may be added of the inventory item 34. Additional details may be added, including a “condition” of the furniture inventory 34. The “condition” may be determined based on visual observation, a formula, or the like. FIG. 10 depicts an exemplary interface 150 for a user to enter additional information regarding the furniture.

FIG. 11 depicts an interface 160 for a user to enter yet additional, and more specific, information corresponding to dimensions of a specific piece of furniture inventory 34. Once you have entered in an item, and are ready to enter in another, a plus sign may be selected.

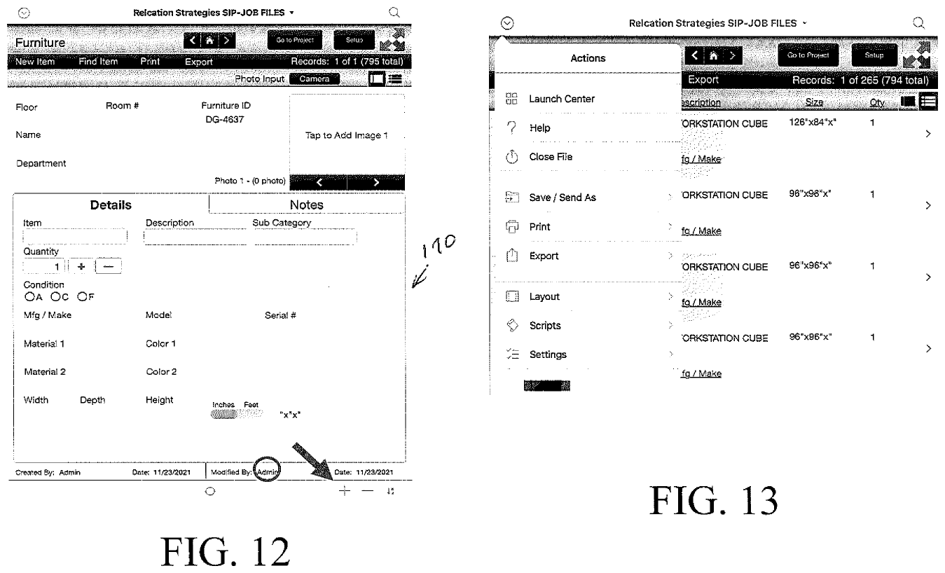

FIG. 12 depicts an area 170 identifying the person modifying information of the system 10, 20. The person may be a manager, or other person, having appropriate credentials. FIG. 13 presents options available with regard to the system in screen 180.

In summary, and as stated above, the database may be configured to receive the data and store the data as a record in the database. The record in the database includes a condition of the inventory item, and a process module identifies a condition of the inventory item, wherein a second location is determined based on the condition. A second location and/or third location may include an alternative space, building, or a place to donate or dispose of the furniture inventory. This saves significant time and money in the relocation process.

Herein is disclosed a customizable software to satisfy any project requirement. The design of the software captures photos, quantities, sizes, manufacturer and assigns a grade for the condition if suggested to reuse or not. Multiple inventories can be recorded simultaneously and combined into one database for sorting purposes for disposition, barcoding and creating budgets for new furniture needed.

What is claimed is:

1. A system for space planning for workspace changes, including:
a handheld device configured to generate data corresponding to an inventory item at a first location;
a database configured to receive the data and store the data as a record in the database;
the record in the database including a condition of the inventory item; and
a process module identifying the condition of the inventory item, wherein a second location is determined based on the condition.

2. The system of claim 1, wherein a plurality of handheld devices input data into the database simultaneously.

3. The system of claim 1, wherein the handheld device includes a camera.

4. The system of claim 1, wherein the inventory item is a piece of furniture.

5. The system of claim 1, wherein the database record further includes an identification of the inventory item.

6. The system of claim 5, wherein the database record further includes a picture.

7. The system of claim 1, further including a third location, wherein the inventory item is sent to the third location based on a different condition of the inventory item.

8. The system of claim 1, wherein the handheld device displays a virtual arrangement of the workspace.

9. A method for space planning for workspace changes, including steps of:
generating data corresponding to an inventory item at a first location using a handheld device;
receiving the data at a database and storing the data as a record in the database;
including a condition of the inventory item in the record;
identifying the condition of the inventory item using a process module; and
determining a second location based on the condition.

10. The method of claim 9, wherein a plurality of handheld devices input data into the database simultaneously.

11. The method of claim 9, wherein the handheld device includes a camera.

12. The method of claim 9, wherein the inventory item is a piece of furniture.

13. The method of claim 9, wherein the database record further includes an identification of the inventory item.

14. The method of claim 13, wherein the database record further includes a picture.

15. The method of claim 9 system of claim 1, further including a third location, wherein the inventory item is sent to the third location based on a different condition of the inventory item.

16. The method of claim 9, wherein the handheld device displays a virtual arrangement of the workspace.
